(19) United States
(12) Patent Application Publication
(10) Pub. No.: US 2026/0346915 A1
(43) Pub. Date: Nov. 5, 2026

(54) VEHICLE COMPONENT HAVING A STEERING INPUT DEVICE FOR INPUTTING A STEERING COMMAND ACCORDING TO THE STEER-BY-WIRE CONCEPT, AND METHOD

(71) Applicant: INVENTUS Engineering GmbH, St. Anton i.M. (AT)

(72) Inventor: Stefan Battlogg, St. Anton i.M. (AT)

(21) Appl. No.: 19/118,855

(22) PCT Filed: Oct. 4, 2023
(86) PCT No.: PCT/EP2023/077474

§ 371 Date: Apr. 7, 2025

(30) Foreign Application Priority Data
Oct. 5, 2022 (DE) 10 2022 125 709.6

(51) Int. Cl. B62D 6/00; B62D 5/04

(52) U.S. Cl. CPC B62D 6/008; B62D 5/0469; B62D 5/0484

(57) ABSTRACT

A vehicle component having a steering input device for inputting a steering command according to the steer-by-wire concept. The vehicle component has a steering unit, an actuator device, a control device, a diagnosis device for identifying failure of the steering input device, and a fault protection device controllable by the diagnosis device and acts on the steering unit in the event of a failure identified by the diagnosis device. The fault protection device has an emergency braking device, which cancels a braking effect if there is a defined power supply and provides the braking effect if the defined power supply ceases and brakes the mobility of the steering unit with a targeted emergency braking torque. The diagnosis device switches an interruption device into a fault mode, so the power supply to the failure braking device is interrupted and the emergency braking device provides the emergency braking torque.

The invention relates to a vehicle component with a steering input device for inputting a steering command according to the steer-by-wire concept. The steering input device comprises at least one movable steering unit and at least one actuator device for generating a torque acting on the steering unit.

High demands are placed on such steering control devices. For example, precise steering feedback and steering behavior that is free of play or jerks, particularly around the center position, as well as very smooth, harmonious steering behavior are required. In addition, the steering device must provide high torques or be able to counteract the manual steering movement (the torque then corresponds to a braking torque). This is necessary, for example, to represent end stops, to support the driver when getting out, or as a counter torque for very fast twists or steering movements.

For this reason, steering systems with an electric motor have become known, which is coupled to the steering wheel either directly or via a reduction gear or (toothed) belt. Such directly attached electric motors generate, for example, active braking torques (nominal torques) of up to eight Newton meters (Nm) and short-term passive braking torques of up to 25 Nm.

Another requirement for steering control devices concerns safety in the event of a malfunction, for example, in the event of a power failure or a failure of the components that generate the torque (failsafe case). Because there is no longer any torque opposing the steering movement, steering is very easy and no resistance is felt when steering. For example, if an electric motor suddenly fails when turning into a bend, the torque in the steering line that counteracts the manual steering movement drops abruptly. This can lead to an unintentional command of a strong steering angle via the steering wheel (oversteering). This results in a very dangerous driving situation that must be corrected by the driver. This can even lead to a loss of control of the vehicle if the driver oversteers into the oncoming lane or over the edge of the road, for example on a winding mountain road.

The known steering systems with failure protection, which can be used to intercept such failures, are usually highly redundant and complex and therefore require a lot of installation space and are expensive. This also makes error evaluation very complicated. In the state of the art (e.g. DE 10 2018 124 499 A1), it is known that the high requirements for the reliability of a steer-by-wire unit can be met by triple failure safety redundancy.

If a corresponding fault is detected, for example, by means of a diagnostic device, another electric motor or another winding of the electric motor is often activated in order to generate the braking torque. To ensure a high level of safety, the control device (ECU, Electronic Control Unit) is also designed in duplicate in addition to the other electric motor or the other winding. In addition, various other components must be designed at least in duplicate in order to meet the requirements.

For example, in order to be able to control a motor with two redundant windings in the event of a fault, two ECUs and two connectors, data lines and cables are required. If one winding or one ECU fails, one still remains active. The two ECUs must be equipped with components from different production batches so that a systematic error in one component cannot have a synchronous (not simultaneous) effect. Two On-board batteries are required to power the motor if one battery fails. The motor must also be able to drive and brake, which requires power in every case (4-quadrant operation). The direction of rotation and deflection must also always be processed in the ECU in order to control the motor of the steering control device.

In contrast, the object of the present invention is to provide an improved vehicle component. In particular, the vehicle component should offer a high level of safety even in the event of a malfunction and at the same time be easy to implement and economically manufacture in terms of design and installation space.

This object is achieved by a vehicle component with the features of claim 1. The method according to the invention is the subject of claim 20. Preferred developments of the invention are the subject of the dependent claims. Further advantages and features of the present invention emerge from the general description and from the description of the exemplary embodiments.

The vehicle component according to the invention comprises a steering input device for inputting a steering command according to the steer-by-wire concept. The steering input device comprises at least one movable steering unit and in particular a steering wheel. The steering input device comprises at least one actuator device for generating a torque acting on the steering unit. The steering input device comprises at least one control device for controlling the actuator device in order to adjust the torque acting on the steering unit. The steering input device comprises at least one diagnostic device for detecting a fault in the steering input device. In particular, the actuator device provides an impermissible torque acting on the steering unit in the event of such a fault. The steering input device comprises at least one fault protection device that can be controlled by the diagnostic device. The fault protection device is suitable and designed to act on the steering unit in the event of a fault detected by the diagnostic device, so that the steering unit cannot be moved without resistance. The fault protection device comprises at least one fault braking device. The emergency braking device is suitable and designed to cancel its braking effect when there is a defined (sufficient) energy supply and to provide its braking effect when the defined (sufficient) energy supply is lost and to brake the mobility of the steering unit with a targeted emergency braking torque. The emergency protection device comprises at least one interruption device. The interruption device can be controlled in particular by the diagnostic device. The diagnostic device is suitable and designed to switch the interruption device (when an emergency is detected) to an emergency mode so that the energy supply to at least the emergency braking device is interrupted and the emergency braking device provides its emergency braking torque.

The vehicle component according to the invention offers many advantages. The combination of the special emergency braking device and the interruption device offers a significant advantage. The braking device enables particularly reliable braking of the steering unit so that it cannot be moved without resistance. Because the emergency braking device provides its braking effect without a power supply, the emergency protection can be implemented very simply and economically. There is no need for a complex and often error-prone control system. The interruption device offers an inexpensive and reliable way of specifically triggering the emergency braking device in the event of an emergency. The interruption device only has to interrupt the power supply to the emergency braking device in the event of an emergency. The emergency braking torque is preferably in a range from 1.0 Nm to 4 Nm, preferably in a range from 1.5 Nm to 3 Nm. For example, the emergency braking torque can be 2 Nm.

Preferably, the interruption device is suitable and designed to also interrupt the power supply of the actuator device in the event of a fault. This has the advantage that the actuator device can no longer generate an impermissible or undesirable torque in the event of a fault. This can, for example, prevent the steering unit from being blocked by the actuator device or being rotated in an undesirable manner in the event of a fault. Particularly preferably, the interruption device disconnects at least one supply line which is provided both for the actuator device and for the fault-incident braking device. It is also possible for the interruption device to interrupt at least one supply line for the actuator device and for the fault-incident braking device. It is possible for the fault-incident braking device to be provided at least partially by the actuator device (e.g. service braking device and/or clutch device). Interrupting the power supply of the actuator device can then correspond to interrupting the power supply of the fault-incident braking device.

An impermissible torque acting on the steering unit, which is detected by the diagnostic unit according to the invention in the event of a fault in the steering control device, is understood to mean in particular a torque which has a safety-relevant influence on the steering and/or driving characteristics of the vehicle. In particular, the torque can be impermissibly high or impermissibly low (in relation to a specified target value). Such a fault occurs, for example, when the actuator device cannot provide the 6 torque acting on the steering unit. For example, if the control of the actuator device is faulty or the actuator device is defective and does not provide any torque. A fault also occurs, for example, when the actuator device exerts an impermissibly high torque. This is the case, for example, if the actuator device is energized impermissibly and/or with an impermissibly high current. By detecting the fault, the fault braking device and, if applicable, the actuator device can be brought into a safe state that is not dangerous for the driver.

In particular, the steering input device comprises at least one power electronics device, which can preferably be controlled by the control device. In particular, the emergency braking device and/or the actuator device are supplied with electrical energy by means of the power electronics device. In particular, the interruption device interrupts the energy supply to the power electronics device in the event of an error. Alternatively or additionally, it can be provided that the interruption device interrupts the energy supply to the components connected to the power electronics device (in particular the emergency braking device and/or the actuator device) in the event of an error.

In particular, a common power electronics device is provided for the emergency braking device and the actuator device. In particular, the interruption device separates a supply line between the power electronics device and an energy storage device linked to it, for example a vehicle battery.

In an advantageous development, the control device and the power electronics device are each supplied with electrical energy via at least one of their own supply lines. In particular, in the event of a fault, the interruption device interrupts the supply line of the power electronics device, while the supply line of the control device is maintained. In particular, the interruption device does not interrupt the supply line of the control device. This means that the emergency braking device can be reliably activated while the control device continues to be available for executing steering commands and/or for diagnosis by at least one higher-level control level of a vehicle electronics system.

In particular, the control device and the power electronics device are connected to at least one (common) energy storage device. For example, at least one vehicle battery is provided for this purpose. It is also possible for the control device and the power electronics device to be connected to at least one separate energy storage device each.

In an advantageous development, it is provided that the diagnostic device and the interruption device are supplied with energy together with the control device. In particular, these components have at least one common energy storage device. In particular, these components are supplied with energy via at least one common supply line.

In a preferred and advantageous development, the diagnostic device comprises at least two diagnostic units. In particular, the diagnostic units are designed to be redundant. In particular, the diagnostic units are each suitable and designed to process (independently of one another) at least partially the same input data and to provide diagnostic data therefrom.

Preferably, the diagnostic device is suitable and designed to use the diagnostic data of at least two diagnostic units to detect a fault and preferably to compare them. Preferably, the diagnostic units are designed to mutually monitor their diagnostic data and preferably compare. It is also possible for the diagnostic device to comprise at least one higher-level unit which evaluates the diagnostic data of the diagnostic units and in particular compares them with one another.

In particular, the diagnostic device is suitable and designed to detect the presence of a fault depending on the result of the comparison of the diagnostic data of the at least two diagnostic units. For example, a fault is detected if the diagnostic data differ from one another by a defined amount and/or by a defined parameter. It is possible for such a comparison to be carried out by the individual diagnostic units themselves. It is also possible for such a comparison to be carried out by a higher-level unit that is operatively connected to the diagnostic units.

It is advantageous and preferred that the interruption device comprises at least two interruption units. In particular, the interruption units are designed to be redundant. In particular, the interruption units can each be switched to the fault mode independently of one another (by means of the diagnostic device). In particular, the interruption units can each interrupt the energy supply to the fault braking device and/or the actuator device independently of one another.

In particular, the diagnostic device can control the interruption units separately. It can be provided that the diagnostic device always switches both interruption units to the fault mode in the event of a fault. It is also possible for the diagnostic device to specifically select at least one interruption unit and switch it to the fault mode. Preferably, at least one diagnostic unit is assigned to each interruption unit. It is advantageous and preferred that the diagnostic units each control their assigned interruption unit and can switch to fault mode. In particular, the diagnostic units can each control their assigned interruption unit and switch it to fault mode independently of the consent of at least one other diagnostic unit. In particular, an individual diagnostic unit can switch the interruption unit to fault mode as soon as it assumes a fault. It can also be provided that the diagnostic units can only switch the interruption device to fault mode with the consent of the other diagnostic unit and/or a higher-level unit.

In an advantageous embodiment, it is provided that the diagnostic units are each suitable and designed to switch their associated interruption unit into the fault mode depending on a comparison of their diagnostic data with the diagnostic data of at least one other diagnostic unit. Preferably, a diagnostic unit can switch its associated interruption unit into the fault mode even if its own diagnostic data do not indicate a fault, but at least partially differ from the diagnostic data of the other diagnostic unit.

The interruption device comprises in particular at least one breaker. The breaker is preferably designed as semiconductor breaker and/or electromechanical breaker and/or phase separator. The semiconductor breaker comprises in particular at least one metal oxide semiconductor field effect transistor (MOSFET). Other suitable types of breaker are also possible. The interruption units preferably each comprise at least one breaker or are designed as such. In particular, the interruption device comprises at least one electronic and/or electrical and/or electromechanical switch for isolating the power supply.

In all embodiments, it is preferred that the steering input device comprises at least one sensor device. In particular, the sensor device is provided with the control device operatively connected. In particular, the sensor device comprises at least two, preferably three, sensor units. In particular, the sensor units are designed redundantly. In particular, the sensor units each serve to detect a parameter characteristic of the position of the steering unit (e.g. angle of rotation). Additionally, or alternatively, at least one sensor unit can also be designed to detect a torque applied to the steering unit.

It is preferred and advantageous that at least the sensor units are supplied with energy regardless of whether the interruption device is in the fault mode or not. In particular, in the event of a fault, the energy supply to at least the sensor units is maintained. In particular, in the event of a fault, the steering command can be passed on to the steering device, thus enabling safe continued travel.

Preferably, at least the sensor units are supplied by means of at least one energy storage device. In particular, the energy storage device is designed to be redundant to an energy storage device of the control device and/or the actuator device. In particular, the sensor units each have at least one of their own energy storage device and/or at least one common energy storage device. It is also possible for the sensor units to share an energy storage device with the control device.

In an advantageous development, at least the sensor units are operatively connected to a steering device, bypassing the control device. This preferably ensures that their signal is available for the steering device even if the control device fails. The sensor units are preferably also operatively connected to the steering device via the control device.

In particular, the sensor units send their signals to the control device, which then controls the steering device accordingly. In particular, the sensor device has at least two, preferably three, redundant active connections to the steering device. In particular, one active connection leads to the steering device via the control device and at least one active connection leads to the steering device bypassing the control device. Particularly preferably, at least two redundant active connections to the steering device are provided for each sensor unit.

It is possible and advantageous for the emergency braking device to brake independently of the direction of rotation of the steering unit. In particular, the emergency braking device brakes independently of direction. In particular, the emergency braking device does not require any means to adapt its braking effect depending on the direction of rotation. This saves controls and components as well as installation space. In particular, the emergency braking device is suitable and designed to brake the rotational movement of the steering unit regardless of whether the steering unit is rotated clockwise or anti-clockwise.

In particular, the emergency braking device is suitable and designed to provide its braking effect and to brake the mobility of the steering unit even in the event of a failure of the power supply for the emergency protection device. In particular, in the event of a failure of its power supply, the emergency braking device provides the braking effect regardless of whether other components, for example the control device and/or the diagnostic device and/or the interruption device, are supplied with power or not. In other words, the emergency braking device preferably always brakes when it is no longer supplied with power. In particular, the emergency braking device brakes in the event of a total failure of the power supply, even if the interruption device has not (yet) disconnected. In a preferred and advantageous development, the accident braking device comprises at least one magnetorheological braking device. In particular, the magnetorheological braking device comprises at least one permanent magnet device. In particular, the permanent magnet device provides at least one defined magnetic field.

The magnetorheological braking device preferably comprises at least two brake components that can be rotated relative to one another. In particular, at least one of the brake components can be rotated by the steering unit. In particular, at least one other of the brake components is supported in a rotationally fixed manner. In particular, at least one gap that is at least partially filled with a magnetorheological medium is formed between the brake components. In particular, the medium can be influenced by means of a magnetic field of the permanent magnet device in such a way that braking is carried out with the emergency braking torque.

In particular, the magnetic field of the permanent magnet device can be reduced in normal operation by at least one electrical coil device, so that the braking effect is canceled. In particular, the electrical coil device is specifically controlled by the control device and/or the emergency stop device in normal operation in order to reduce the magnetic field of the permanent magnet device. In particular, the coil device generates a magnetic field in normal operation which is specifically opposite to the magnetic field of the permanent magnet device. As a result, a low basic torque of preferably less than 0.4 Nm, preferably less than 0.3 Nm, can be provided in normal operation.

In particular, the coil device is supplied with energy via a supply line, which is deliberately interrupted by the interruption device in the event of a fault. In particular, the interruption device is suitable and designed to deliberately interrupt the energy supply to the coil device in the event of a fault. In particular, it is provided that that in the event of an interruption in the power supply, the coil device can no longer counteract the magnetic field of the permanent magnet device and thus the emergency braking torque is available.

The permanent magnet device can be provided by a remanence device or at least comprise such a device. In particular, the remanence device is suitable and designed to specifically magnetize at least one component of the braking device so that this component then provides a magnetic field (in the manner of a switchable permanent magnet). In particular, the component can also be demagnetized again (in particular by an electrical coil device).

Additionally, or alternatively, the emergency braking device can comprise at least one mechanical friction brake with at least one energy accumulator or can be designed as such. The emergency braking device can basically be designed as a mechanical, hydraulic, pneumatic, electrical, magnetic and/or electromagnetic brake.

In particular, the emergency braking device must be actively maintained in the unbraked state using supplied energy. In particular, the braking device switches to the braked state (independently) without using supplied energy. This means that the emergency braking torque can be applied even if, for example, there is a total power failure.

The emergency braking device can comprise at least one energy storage device which provides the energy required to apply the emergency braking torque. The emergency braking device can comprise a mechanical, hydraulic, pneumatic, electrical, magnetic and/or electromagnetic energy storage device. For example, a (mechanical) spring, a pressure accumulator, a rechargeable battery, a battery and/or a capacitor or the like can be provided. It is possible that the emergency braking torque can be adjusted by selecting the energy storage device.

The actuator device preferably comprises at least one (electric) motor device and/or at least one service brake device for generating a torque acting on the steering unit.

The motor device can preferably be used to reset the steering unit to a neutral position. The resistance to deflection of the steering unit from the neutral position can preferably be adjusted, in particular continuously, using the motor device. The actuator device can comprise at least one (self-locking) gear device which is coupled to the motor device.

The service brake device preferably serves to brake a movement of the steering unit with a (adjustable and/or fixed) braking torque. The service brake device preferably enables the generation of braking torques, in particular continuously adjustable ones, which counteract a deflection of the steering unit, in particular from the neutral position of the steering unit. In particular, end stops with a high braking torque, for example, more than 15 Nm, preferably more than 20 Nm, can be represented by means of the service brake device.

The actuator device preferably comprises both a motor device and a service brake device. This makes it possible to select a relatively small motor device which is only used, for example, to return the steering unit to the neutral position. For example, the motor device can have a nominal torque of less than 10 Nm, preferably less than 7 Nm, for example, 5 Nm. The service brake device can be designed, for example, for a maximum service brake torque of 25 Nm.

In an advantageous embodiment, the service brake device can be designed as a clutch device or at least comprise such a device. For example, such an embodiment is provided when the motor device is operatively connected to the steering device via, in particular, a self-locking, gear device. In particular, the clutch device and the motor device are connected in series with one another and/or connected in series with the steering unit. In particular, at least one controllable magnetorheological clutch device is provided. In particular, a torque that can be transmitted between the motor device and the steering unit can be specifically changed by means of the clutch device. It is possible for the emergency braking device to be structurally integrated into the clutch device. In particular, the emergency braking device is at least partially provided by the clutch device.

Preferably, the service brake device is designed magnetorheologically or comprises at least one magnetorheological (service) brake device. Particularly preferably, the emergency brake device is structurally integrated into the service brake device of the actuator device. In particular, the emergency brake device is at least partially provided by the service brake device. In particular, the emergency brake device and the service brake device have at least two common brake components that can be rotated relative to one another and/or at least one common gap that is at least partially filled with a magnetorheological medium.

In particular, the service brake device has at least one coil device, by means of which the magnetic field of the permanent magnet device of the emergency braking device is reduced or eliminated in normal operation. In particular, a power supply to the coil device of the service brake device can be interrupted in the event of an emergency by means of the interruption device. It is possible for the emergency braking device to be provided by integrating a permanent magnet device into the service brake device. In particular, the service brake device is suitable and designed to generate a higher braking torque than the emergency braking device. It is possible and advantageous for the emergency braking device to be able to provide (only) a (fixed) lower braking torque than the service brake device.

The vehicle component can comprise at least one steering device for converting a steering command specified by the steering input device into a chassis movement. In particular, the steering input device (in particular its steering unit) and the steering device are only operatively connected in normal operation according to the steer-by-wire concept. In particular, the steering device has its own energy supply, which is at least partially independent of the energy supply of the steering input device. In particular, the energy supply of the steering device is independent of the control device and/or the diagnostic device and/or the fault protection and/or the actuator device. In particular, the steering input device and the steering device each have at least one energy storage device of their own.

For example, two separate vehicle batteries and/or at least two other suitable separate energy storage devices are provided for this purpose.

The method according to the invention serves to operate the vehicle component according to the invention or one of its embodiments. In particular, the method is designed such that the steering input device described here can be operated accordingly.

The diagnostic data particularly comprise at least one parameter which is also used by the control device to control the actuator device. The diagnostic data particularly comprise at least one parameter which is provided by the sensor device. In particular, the diagnostic data comprise a large number of such parameters. Such characteristic quantities are, for example, measured values, setpoints and/or signal values transmitted by sensors and/or actuators.

The diagnostic device is particularly suitable and designed to detect a fault in which the actuator device can no longer provide the torque acting on the steering unit (so that the steering unit could therefore be moved without resistance if no further measures are taken) and/or in which the actuator device generates too high a torque acting on the steering unit. In particular, the diagnostic device monitors at least one parameter and/or other input data and determines diagnostic data therefrom and detects a fault depending on the diagnostic data.

In particular, at least one or more (vehicle) batteries and/or additional batteries or the like are available as energy storage devices. A battery is also understood to mean an accumulator.

The sensor device (preferably its sensor units) and/or the control device and/or the diagnostic device and/or the steering device are in particular at least partially supplied with energy independently of the switching position of the interruption device. In particular, these components can each be at least partially equipped with at least one energy storage device and/or a separate supply line.

In the context of the present invention, a failure of the drive device is understood to mean in particular that the actuator device can no longer generate torque or the actuator device assumes an undesirable state in which too high a torque is generated (in extreme cases up to a blockage of the actuator device) or an impermissible state (e.g. overheating of the actuator device) occurs. In particular, the steering unit would be able to move without resistance in the event of a failure if no failure protection was provided. The torque acting on the steering unit can be designed as a drive torque or also as a braking torque. The braking torque can be generated by braking or by driving in the opposite direction.

The steering unit can comprise at least one joystick or be designed as such. The joystick has at least one or only one (rotational) degree of freedom. The joystick with only one (rotational) degree of freedom can also be referred to as an operating lever. The joystick can be equipped with (at least) two or more degrees of freedom. In particular, the joystick can be pivoted about at least one axis. The pivot angle is, for example, (at most)+/−45° or less starting from a neutral position. However, larger pivot angles are also possible. In particular, the accident protection is suitable and designed to act on the degrees of freedom of the joystick separately and/or together (or simultaneously).

The vehicle component presented here can be used in motor vehicles (e.g. cars, trucks, ON-highway vehicles), aircraft, airplanes (including drones), ships, boats, in agricultural and forestry technology, for example in tractors or combine harvesters, harvesting machines and other field machines (OFF-highway vehicles). It can also be used in construction or mobile work machines and, for example, forklifts or similar machines or in simulators for simulating vehicle control (gaming; sim racing; computer peripherals . . . ). The vehicle component can also be used in particular for at least partially or completely autonomous vehicles. For example, the vehicle component can be used in a so-called people mover. Such vehicles are usually automatic or autonomous (public) means of transport and are also called “shuttle vehicles” or “shuttle buses”. For manual (steering) operation, a steering unit (e.g. a joystick or a steering wheel) can be provided, which is operated by a driver or passenger.

Further advantages and features of the present invention will become apparent from the embodiments which are explained below with reference to the accompanying figures.

Shown here:

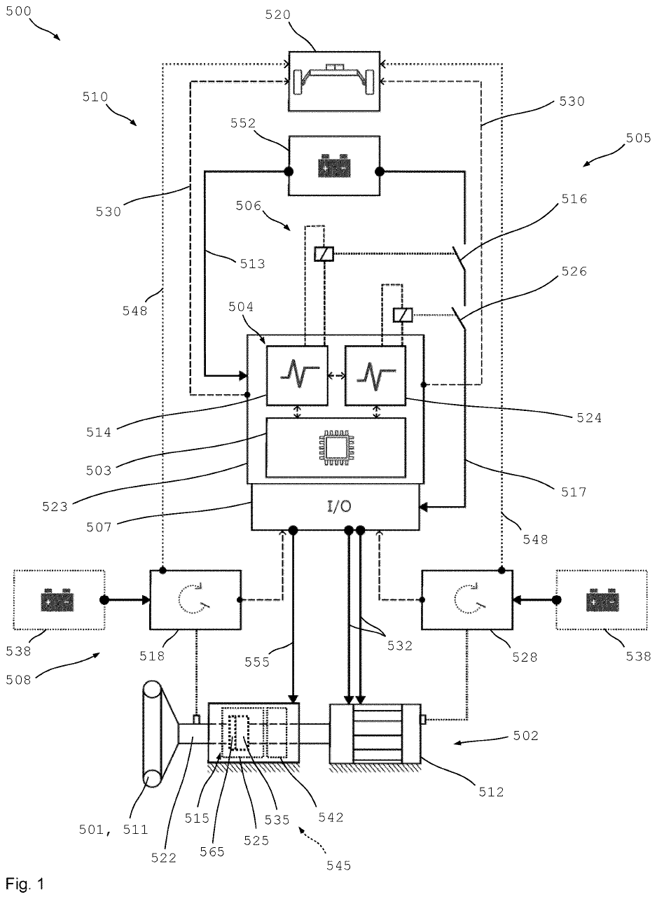

FIG. 1 is a purely schematic representation of a wiring diagram of a vehicle component according to the invention;

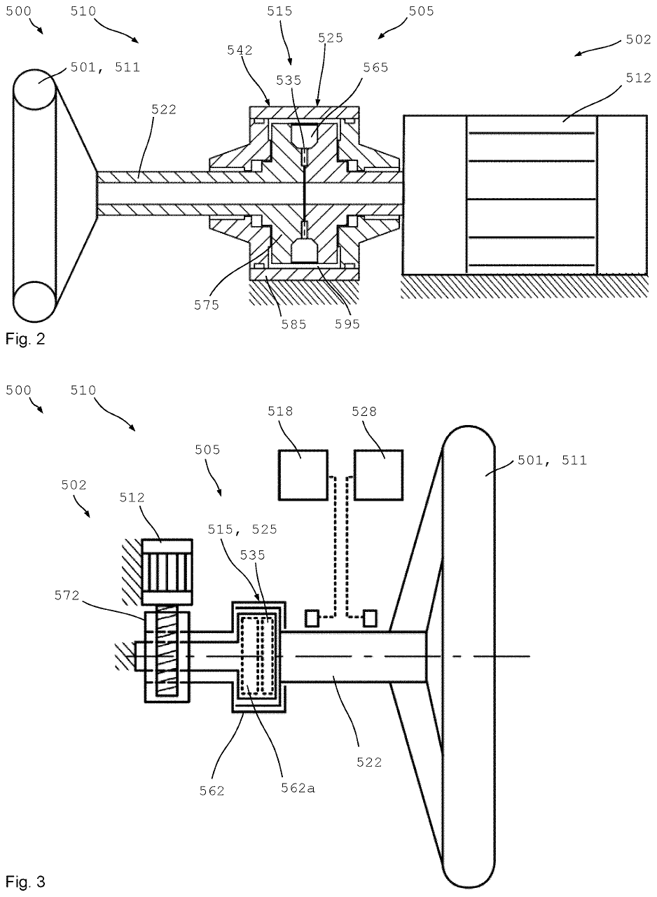

FIG. 2 is a purely schematic detailed representation of the vehicle component with an alternative steering control device;

FIG. 3 is a purely schematic detailed representation of the vehicle component with another steering control device; and

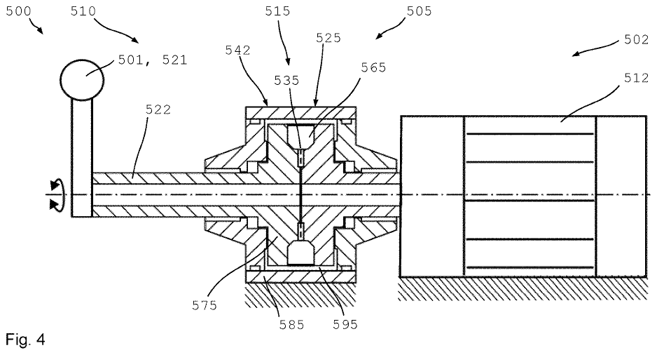

FIG. 4 is a purely schematic detailed representation of the vehicle component with a different steering control device.

FIG. 1 shows a vehicle component 500 according to the invention with a steering control device 510 for controlling a vehicle according to the steer-by-wire concept. For this purpose, a steering wheel 511 formed steering unit 501 is electrically or electronically connected to a steering device 520. The steering device 512 can, for example, adjust the wheels of the vehicle. The vehicle component 500 is operated here according to the method according to the invention.

The movement or position of the steering unit 501 is detected here with a sensor device 508 with, for example, two sensor units 518, 528. The sensor units 518, 528 are designed here as angle of rotation sensors. The sensor units 518, 528 are designed here with (double) redundancy and have each have their own energy storage device 538. The energy storage devices 538 can be provided, for example, by separate or local batteries or by a (second) vehicle battery.

A control device 503 (ECU) controls the steering device 520 depending on the received sensor signals. The components shown here communicate with each other, for example, via a CAN bus system of the vehicle and/or via separate lines.

The steering input device 510 comprises an actuator device 502 with an electric motor device 512, which is connected to the steering unit 501 via a steering shaft 522. This generates a torque acting on the steering unit 501, so that the steering unit 501 can be actively turned to the right or left, for example.

The actuator device 502 here comprises a magnetorheologically designed service brake device 542 in order to brake the mobility of the steering unit 501 in addition to the motor device 512. Such a service brake device 542 enables, for example, the use of a particularly compact or smaller motor device 512.

The actuator device 502 can be used to simulate forces such as would be felt on the steering unit 501 with a mechanical steering system. For this purpose, for example, a torque acting on the steering unit 501 (so-called passive torque) is generated, which counteracts the manual movement. This torque can be generated here with the motor device 512 or the service brake device 542.

The actuator device 502 is controlled and supplied with energy via a power electronics device 507. The power electronics device 507 is in turn controlled by the control device 503. The energy is supplied by an energy storage device 552 and, for example, one or more vehicle batteries. For example, the power electronics device 507 is fed directly from a vehicle battery.

The power electronics device 507 and the motor device 512 are connected here via two supply lines 532. For example, each supply line 532 supplies its own winding or its own motor, so that the motor device 512 is also designed redundantly.

To monitor the proper operation of the vehicle component 500, a diagnostic device 504 with two redundant diagnostic units 514, 524 is provided here. In the embodiment shown here, the control device 503 and the diagnostic device 504 are integrated in a common control unit.

The diagnostic device 504 receives, for example, input data from the control device 503 and the sensor device 508. From these and possibly other input data, the diagnostic device 504 determines diagnostic data that describe the operating state. The diagnostic device 504 can thus determine whether a malfunction has occurred in which the actuator device 502 can no longer provide the torque acting on the steering unit 501 with the desired value (torque too high or too low).

In an embodiment not shown here, at least three sensor units 518, 528 can be provided. This enables a 2-out-of-3 logic. If two sensor units 518, 528 determine the same measured value, the error can be assigned to the third sensor unit 518, 528 and further travel is possible.

To ensure that the steering unit 501 cannot be turned without resistance in the event of a fault, a fault protection device 505 is provided that can be controlled by the diagnostic device 504. The fault protection device 505 comprises an emergency braking device 515 with a magnetorheologically designed braking device 525. In a variant not shown in detail here, the emergency braking device 515 can also comprise a mechanical friction brake 545.

If the emergency braking device 515 is supplied with sufficient energy, its braking effect is cancelled; it cannot brake the movement of the steering unit 501. If the energy supply fails, the emergency braking device 515 provides its braking effect and brakes the steering unit with a targeted emergency braking torque. The emergency braking device 515 does not require a signal from the sensor device 508 or the control device 503, which makes the fault protection device 505 particularly reliable and safe.

In order to be able to specifically interrupt the power supply of the emergency braking device 515 in the event of an incident, an interruption device 506 that can be controlled by the diagnostic device 504 is provided here. If the diagnostic device 504 detects an incident, it switches the interruption device 506 to a fault mode, whereby the power supply of the emergency braking device 515 and also of the entire actuator device 502 is interrupted.

The interruption device 506 interrupts a supply line 517 which leads from the energy storage device 552 to the power electronics device 507. A separate supply line 513 which comes from the energy storage device 552 and supplies the control device 503 and the diagnostic device 504 is not interrupted. The supply line 513 can also be designed redundantly.

Due to the interruption of the energy supply for the power electronics device 507, the actuator device 502 is no longer active. In addition, the energy supply of an electrical coil device 565 of the magnetorheological braking device 525 is interrupted. The service braking device 542 and also the emergency braking device 515 (or its coil device 565) are connected to the power electronics device 507 via a supply line 555.

In normal operation, the coil device 560 serves to counteract a magnetic field of a permanent magnet device 535. When the coil device 565 is active in normal operation, the braking device 525 has no braking effect and does not influence the mobility of the steering unit 501.

Without the magnetic field of the coil device 565, the magnetic field of the permanent magnet device 535 causes the mobility of the steering unit 501 to be braked with the emergency braking torque. The permanent magnet device 535 has the advantage that the braking device 525 can provide the desired emergency braking torque reliably and even over a longer period of time without any external energy supply.

In order to be able to control the steering device 520 with the desired steering command even in the event of a malfunction, the sensor units 518, 528 are each connected directly to the steering device 520 with their own active connection 548. This means that even if the control device 503 fails, the sensor signals can be passed on directly and the vehicle can continue to be steered safely. In normal operation, the sensor units 518, 528 send their signals to the control device 503, which processes the signals and then passes them on to the steering device 520 via its own active connection 530. To improve safety, two redundant active connections 530 are provided here.

The interruption device 506 here comprises two redundant interruption units 516, 526. Both interruption units 516, 526 are each capable of disconnecting the supply line 517 and thereby braking with the emergency braking device 515.

The interruption units 516, 526 are each assigned to a diagnostic unit 514, 524. The diagnostic units 514, 524 are redundant and monitor each other. To do this, they evaluate the signals from the sensor units 514, 524, for example. If the diagnostic units 514, 524 detect deviations in their own diagnostic data or the diagnostic data of the other diagnostic unit 514, 524, they switch their interruption unit 516, 526 to fault mode. The interruption units 516, 526 are each designed as a breaker and, for example, as a MOSFET semiconductor breaker.

A particular advantage of the invention is that a duplicate version of the control device 503 or other central control components of the steering input device 510 can be dispensed with. In addition, the invention offers a particularly uncomplicated and at the same time reliable error evaluation and remedy in the event of a malfunction.

FIG. 2 shows a steering input device 510 which can be used as an alternative to the previously described steering input device 510 in the vehicle component 500. In the steering input device 510 shown here, the emergency braking device 515 is structurally integrated into the service braking device 542 and is partially provided by the latter.

The service brake device 542 is designed magnetorheologically here and comprises two brake components 575, 585 that can rotate relative to one another and between which a gap 595 is formed. The gap 595 is filled with a magnetorheological medium (not shown here). The service brake device 542 has an electrical coil device 565 for generating a magnetic field.

The magnetic field influences the medium in the gap 595 in such a way that the relative rotation of the brake components 575, 585 is subjected to a defined braking torque. The service brake device 542 is designed here, for example, for a maximum braking torque of 25 Nm.

By combining it with the service brake device 542, the motor device 512 can be considerably lighter and more compact and only has to implement, for example, the active return of the steering unit 501 to the neutral position. If higher braking torques are required, for example to fix the steering unit 501 as an exit aid, the service brake device 542 is used. In addition, the magnetorheologically designed service brake device 542 has the advantage that particularly precise and quickly implemented steering feedback can be set.

The emergency braking device 515 is designed here as a magnetorheological braking device 525. Apart from its permanent magnet device 535, the braking device 525 shares its essential functional components with the service braking device 542 (for example the braking components 575, 585 and the gap 595 as well as the coil device 565). This allows weight, installation space and components to be saved.

In normal operation, the coil device 565 specifically counteracts the magnetic field of the permanent magnet device 535. For example, the magnetic field is eliminated or specifically reduced to such an extent that the permanent magnet device 535 can support the magnetic field of the coil device 565 if necessary. If the service braking torque is to be changed, the coil device 565 is controlled accordingly.

In the event of a fault, the processes described with reference to FIG. 1 take place, whereby, among other things, the power supply to the actuator device 502 and thus to the service brake device 542 and the motor device 512 is interrupted. As a result, the coil device 565 also receives no electrical energy, so that its magnetic field is no longer can influence the magnetic field of the permanent magnet device 535.

As a result, the magnetic field of the permanent magnet device 535 will automatically influence the medium in the gap 595 in such a way that the relative rotation of the brake components 575, 585 is braked with the desired emergency braking torque. This prevents the steering unit 501 from being moved without resistance. For example, the emergency braking torque here is 2 Nm. At the same time, the interruption of the energy supply also ensures that the motor device 512 generates an undesirably high torque in the event of an emergency.

FIG. 3 shows the steering input device 510 can be used as an alternative to the previously described steering input devices 510 in the vehicle component 500. Here, the actuator device 502 is equipped with a magnetorheologically designed coupling device 562. The coupling device 562 and the motor device 512 are connected in series. Two sensor units 518, 528 of the sensor device 508 are also shown here purely schematically.

The torque that can be transmitted between the motor device 512 and the steering unit 501 can be specifically changed by means of the coupling device 562. The torque that can be transmitted by the coupling device 562 is set here by controlling an electrical coil device 562a. The magnetic field of the coil device 562a acts on a magnetorheological medium (not shown in detail here), whereby the relative rotation of the coupling components is specifically slowed down. The more the mobility of the coupling components is slowed down, the higher the torque that can be transmitted.

The actuator device 502 is here provided with a self-locking gear device 572 and, for example, a worm gear. Due to the self-locking, the rotation of the steering unit 501 can be blocked independently of the motor device 512. The braking torque applied to the steering unit 501 or the torque required to move the steering unit 501 depends on how high the torque is that can be transmitted with the coupling device 562.

The emergency braking device 515 is designed here as a magnetorheological braking device 525, which is partially provided by the coupling device 562. For this purpose, the permanent magnet device 535 is housed here within the coupling device 562. In normal operation, the magnetic field of the coil device 562a counteracts the magnetic field of the permanent magnet device 535. As a result, the magnetic field of the permanent magnet device 535 can be eliminated or specifically reduced.

In the event of a fault, the processes described with reference to FIG. 1 take place. The energy supply to the clutch device 562 and the electrical coil device 562a (and thus to the fault braking device 515) is also interrupted. As a result, the magnetic field of the permanent magnet device 535 is available to generate the fault braking torque. A torque equal to the fault braking torque can now be transmitted with the clutch device 562.

Due to the support on the self-locking gear device 572, the emergency braking torque is available even if the motor device 512 has failed or is no longer supplied with energy. In other words, the clutch device 562 can be supported on the self-locking gear device 572 so that it can brake the mobility of the steering unit 501 with the emergency braking torque.

The steering input device 510 shown in FIG. 4 can be used as an alternative to the previously described steering input devices 510 in the vehicle component 500. The steering input device 510 is equipped here with a steering unit 501 designed as a joystick 521. Otherwise, the variant shown here is essentially based on the steering input device 510 presented with reference to FIG. 2.

The joystick 521 has only one (rotational) degree of freedom and can also be referred to as an operating lever. This allows vehicle steering to be implemented in a structurally simple and at the same time reliable manner. The swivel angle of the joystick 521 is, for example, (at most)+/−45° starting from a neutral position. Alternatively, the joystick 521 can also be equipped with two or more degrees of freedom.

In the event of a fault, the variant shown here reacts essentially as described above. In the event of a fault, the fault protection 505 can act separately on both (all) degrees of freedom of the joystick 521. It can also be provided that the fault protection 505 acts on both (all) degrees of freedom together or simultaneously. In this case, a fault also affects the behavior of the other degree of freedom, for example, because the power supply is then interrupted for both degrees of freedom.

### LIST OF REFERENCE SYMBOLS

| | |
|---|---|
| 500 | Vehicle Component |
| 501 | Steering Unit |
| 502 | Actuator Device |
| 503 | Control Device |
| 504 | Diagnostic Device |
| 505 | Fault Protection Device |
| 506 | Interruption Device |
| 507 | Power Electronics Device |
| 508 | Sensor Device |
| 510 | Steering Input Device |
| 511 | Steering Wheel |
| 512 | Motor Device |
| 513 | Supply Line |
| 514 | Diagnostic Unit |
| 515 | Emergency Braking Device |
| 516 | Interruption Unit |
| 517 | Supply Line |
| 518 | Sensor Unit |
| 520 | Steering Device |
| 521 | Joystick |
| 522 | Steering Shaft |
| 523 | Control Unit |
| 524 | Diagnostic Unit |
| 525 | Braking Device |
| 526 | Interruption Unit |
| 528 | Sensor Unit |
| 530 | Active Connection |
| 532 | Supply Line |
| 535 | Permanent Magnet Device |
| 538 | Energy Storage Device |
| 542 | Service Brake Device |
| 545 | Friction Brake |
| 548 | Active Connection |
| 552 | Energy Storage Device |
| 555 | Supply Line |
| 562 | Coupling Device |
| 562a | Coil Device |
| 565 | Coil Device |
| 572 | Gear Device |
| 575 | Brake Component |
| 585 | Brake Component |
| 595 | Gap |

1-20. (canceled)

21. A vehicle component with a steering input device for inputting a steer-by-wire steering command, the vehicle component comprising:
at least one movable steering unit,
at least one actuator device for generating a torque acting on the steering unit;
at least one control device for controlling the actuator device to adjust the torque acting on the steering unit;
at least one diagnostic device for detecting a fault in the steering input device, in which the actuator device provides an impermissible torque acting on the steering unit;
at least one fault protection device configured to be controlled by the diagnostic device and act on the steering unit in the event of a fault detected by the diagnostic device, so that the steering unit cannot be moved without resistance;
the fault protection device having
at least one interruption device controlled by the diagnostic device,
at least one emergency braking device configured to
cancel a braking effect of the fault protection device when there is a defined energy supply, and
provide the braking effect when the defined energy supply is lost and brake the mobility of the steering unit with a targeted emergency braking torque; and
the diagnostic device being configured to switch the interruption device to a fault mode so that the energy supply at least to the emergency braking device is interrupted and the emergency braking device provides the emergency braking torque.

22. The vehicle component according to claim 21, wherein the interruption device is configured to interrupt the energy supply of the actuator device in the event of a fault.

23. The vehicle component according to claim 21, further comprising:
at least one power electronic device controlled by the control device and via which the emergency braking device and/or the actuator device is supplied with electrical energy;
the at least one power electronic device supplying the emergency braking device and/or the actuator device with electrical energy; and
the interruption device being configured to interrupt the energy supply of the power electronic device and/or components connected to the power electronic device in the event of a fault.

24. The vehicle component according to claim 23, wherein the control device and the power electronics device are each supplied with energy via at least one respective supply line; and the interruption device is configured to interrupt the supply line of the power electronics device in the event of a fault while the supply line of the control device is maintained.

25. The vehicle component according to claim 21, wherein the diagnostic device and the interruption device are supplied with energy together with the control device.

26. The vehicle component according to claim 21, wherein the diagnostic device has at least two diagnostic units, each of the at least two diagnostic units being configured to at least partially process an input data and to provide diagnostic data therefrom.

27. The vehicle component according to claim 26, wherein the diagnostic device is configured to use the diagnostic data of the at least two diagnostic units to detect a fault; and the at least two diagnostic units monitor each other's diagnostic data and/or the diagnostic device has at least one higher-level unit which evaluates the diagnostic data of the at least two diagnostic units.

28. The vehicle component according to claim 21, wherein the interruption device has at least two interruption units, each configured to be switched to the fault mode independently of one another.

29. The vehicle component according to claim 28, wherein:
the diagnostic device has at least two diagnostic units, each of the at least two diagnostic units being configured to at least partially process an input data and to provide diagnostic data therefrom;
the interruption units are each assigned to at least one diagnostic unit; and
the diagnostic units can each control their assigned interruption unit and switch the interruption unit to the fault mode.

30. The vehicle component according to claim 28, wherein:
the diagnostic device has at least two diagnostic units, each of the at least two diagnostic units being configured to at least partially process a respective input data and to provide diagnostic data therefrom;
the interruption units are each assigned to at least one diagnostic unit; and
the diagnostic units are each configured to switch their assigned interruption unit to the fault mode based on a comparison of their respective diagnostic data with the diagnostic data of the other of the at least two diagnostic units.

31. The vehicle component according to claim 21, wherein the interruption device has at least one breaker, wherein the breaker is a semiconductor breaker and/or an electromechanical breaker.

32. The vehicle component according to claim 21, further comprising at least one sensor operatively connected to the control device; the at least one sensor having at least two redundant sensor units for detecting a characteristic variable for the position of the steering unit; and the sensor units being supplied with energy regardless of whether the interruption device is in the fault mode or not.

33. The vehicle component according to claim 32, wherein the sensor units are supplied energy by at least one energy store, the at least one energy store is configured to be redundant to an energy store of the control device and/or the actuator device.

34. The vehicle component according to claim 32, wherein the sensor units are operatively connected to a steering device bypassing the control device, so that their signal is available for the steering device even if the control device fails.

35. The vehicle component according to claim 21, wherein the emergency braking device brakes independently of a direction of rotation of the steering unit.

36. The vehicle component according to claim 21, wherein the emergency braking device is configured to provide the braking effect and to brake the mobility of the steering unit even if an energy supply for the emergency protection device fails.

37. The vehicle component according to claim 21, wherein the emergency braking device has at least one magnetorheological braking device with at least one permanent magnet device; and/or the emergency braking device comprises at least one mechanical friction brake with at least one energy accumulator.

38. The vehicle component according to claim 37, wherein:
the magnetorheological braking device has at least two braking components configured to be rotated relative to one another;
at least one of the braking components can be rotated by the steering unit and at least one other of the at least two braking components is supported in a rotationally fixed manner;
at least one gap is formed between the braking components, and the at least one gap is at least partially filled with a magnetorheological medium;
the medium is configured to be influenced by a magnetic field of the permanent magnet device such that braking is carried out with the emergency braking torque; and
the magnetic field of the permanent magnet device is configured to be reduced in normal operation by an electrical coil device so that the braking effect is canceled.

39. The vehicle component according to 21, further comprising at least one steering device for converting a steering command input by the steering input device into a chassis movement; and wherein the steering input device and the steering device are only operatively connected according to the steer-by-wire concept in normal operation and the steering device has an energy supply which is at least partially independent of the energy supply of the steering input device.

40. A method for operating a vehicle component according to claim 21.
